(19) United States
(12) Patent Application Publication
(10) Pub. No.: US 2007/0075505 A1
(43) Pub. Date: Apr. 5, 2007

(54) Sheet-like gasket and process for manufacturing same

(75) Inventors: Katsutoyo Itoi, Hamamatsu-shi (JP); Hiroshi Saito, Hamamatsu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NICHIAS Corporation, Tokyo (JP)

(21) Appl. No.: 11/507,495

(22) Filed: Aug. 22, 2006

(30) Foreign Application Priority Data
Sep. 29, 2005 (JP) 2005-284299

(51) Int. Cl. F16J 15/10

(52) U.S. Cl. 277/650

(57) ABSTRACT

A sheet-like gasket having a dense structure and exhibiting excellent sealing performance with a small clamping force even on an irregular flange surface is provided. The sheet-like gasket is obtained by molding a composition comprising a substrate fiber, a rubber material, a filler, and a rubber chemical into a sheet, having a bead on both sides or one side, and having a flat part with a density of 1.0 g/cm³ or higher, the bead having a density lower than the density of the flat part.

### BACKGROUND OF THE INVENTION

1. Field of the Invention

The present invention relates to a sheet-like gasket used for sealing connections in high-pressure equipment and the like in a wide variety of fields such as petrochemical plants, various industrial machines, vehicles, food and household appliances, and the like.

2. Background Art

A sheet-like gasket is used inserted between flanges of high pressure pipes, for example, when the high pressure pipes are connected. Since the sheet-like gasket is formed by punching a sheet, the sheet-like gasket is easily adaptable to various sizes and unique shapes and is used in a wide field such as petrochemical plants and the like.

The sheet-like gasket is usually manufactured by dispersing a base fiber in water using a refiner, adding rubber materials, fillers, and rubber chemicals to obtain a raw material slurry, processing the raw material slurry using a sheet-making machine to obtain a sheet, and drying the sheet at about 100° C. In some cases, the sheet-like gasket obtained by the sheet-making machine is rolled by, for example, a method of causing the sheet to pass through a hot roller while applying a high load, in order to increase the density of the sheet-like gasket or to flatten the surface of the sheet-like gasket.

A compressed sheet-like gasket obtained by rolling or the like has a dense structure and exhibits higher sealing performance as compared with an uncompressed sheet-like gasket. Therefore, the compressed sheet-like gasket is suitably used particularly in high pressure equipment.

However, the compressed sheet-like gasket is less elastic and exhibits a smaller amount of compression than the uncompressed gasket. Therefore, if such a compressed sheet-like gasket is used on a flange with an irregular surface, clearances are produced between the sheet-like gasket and the flange, which may cause leakage of the content. In such a case, a greater clamping force is required. The larger the sheet-like gasket, the greater the clamping force which is required. In some cases, clamping is difficult.

An object of the present invention is, therefore, to provide a sheet-like gasket having a dense structure and exhibiting excellent sealing performance with a small clamping force even on an irregular flange surface.

### SUMMARY OF THE INVENTION

As a result of extensive research in order to achieve the above object, the present inventors have found that if a bead having a density smaller than the density of a flat part is formed in a sheet-like gasket by applying a compression at a smaller compression rate to a part of the sheet-like gasket during a compression operation before a cross-linking reaction, the sheet-like gasket exhibits sufficient sealing performance even with a small clamping force due to concentration of stress on the bead. This finding has led to the completion of the present invention.

Specifically, the present invention (1) provides a sheet-like gasket comprising a substrate fiber, a rubber material, a filler, and a rubber chemical, having a bead on both sides or one side, and having a flat part with a density of 1 g/cm³ or higher, the bead having a density lower than the density of the flat part.

The present invention (2) provides a sheet-like gasket obtained by a process comprising a slurry preparing step of obtaining a raw slurry containing a substrate fiber, a rubber material, a filler, and a rubber chemical, a molding step of obtaining a gasket substrate sheet by molding the raw slurry into a sheet and drying the sheet, a compression step of obtaining a compressed sheet by compressing the molded gasket substrate sheet and forming a flat part and a bead, and a cross-linking step of obtaining the sheet-like gasket by causing a cross-linking reaction by heating the compressed sheet, wherein the compression rate of the area in which the bead is formed is smaller than the compression rate of the area in which the flat part is formed in the compression step.

The present invention (3) provides a sheet-like gasket comprising a substrate fiber, rubber material, filler, and cross-linking component, having a bead on both sides or one side, and having a flat part with a density of 1 g/cm³, the bead having a density lower than the density of the flat part.

The present invention (4) provides a process for manufacturing a sheet-like gasket comprising a slurry preparing step of obtaining a raw slurry containing a substrate fiber, a rubber material, a filler, and a rubber chemical, a molding step of obtaining a gasket substrate sheet by molding the raw slurry into a sheet and drying the sheet, a compression step of obtaining a compressed sheet by compressing the molded gasket substrate sheet and forming a flat part and a bead, and a cross-linking step of obtaining the sheet-like gasket by causing a cross-linking reaction by heating the compressed sheet, wherein the compression rate of the area in which the bead is formed is smaller than the compression rate of the area in which the flat part is formed in the compression step.

According to the present invention, a sheet-like gasket having a dense structure and exhibiting excellent sealing performance with a small clamping force even on an irregular flange surface can be obtained.

### BRIEF DESCRIPTION OF THE DRAWINGS

FIG. 1 is the sheet-like gasket of one embodiment of the present invention.

FIG. 2 shows cross-sectional configurations of beads.

FIG. 3 is a schematic diagram showing a compression process to obtain a compressed sheet from a gasket substrate sheet.

FIG. 4 shows a die A of Example 1.

FIG. 5 shows a die B of Example 2.

FIG. 6 shows a die C of Example 3.

### DETAILED DESCRIPTION OF THE INVENTION AND PREFERRED EMBODIMENTS

The sheet-like gasket of the first embodiment of the present invention (hereinafter referred to from time to time as “sheet-like gasket (1) of the present invention”) is a sheet-like gasket obtained by molding a composition comprising a substrate fiber, a rubber material, a filler, and a rubber chemical, having a bead on both sides or one side, and having a flat part with a density of 1 g/cm³ or higher, the bead having a density lower than the density of the flat part.

The sheet-like gasket of the second embodiment of the present invention (hereinafter referred to from time to time as “sheet-like gasket (2) of the present invention”) is a sheet-like gasket obtained by a process comprising a slurry preparing step of obtaining a raw slurry containing a substrate fiber, a rubber material, a filler, and a rubber chemical, a molding step of obtaining a gasket substrate sheet by molding the raw slurry into a sheet and drying the sheet, a compression step of obtaining a compressed sheet by compressing the molded gasket substrate sheet and forming a flat part and a bead, and a cross-linking step of obtaining the sheet-like gasket by causing a cross-linking reaction by heating the compressed sheet, wherein the compression rate of the area in which the bead is formed is smaller than the compression rate of the area in which the flat part is formed in the compression step.

The sheet-like gasket of the third embodiment of the present invention (hereinafter referred to from time to time as “sheet-like gasket (3) of the present invention”) is a sheet-like gasket comprising a substrate fiber, a rubber material, a filler, and a cross-linking component, having a bead on both sides or one side, and having a flat part with a density of 1 g/cm³ or higher, the bead having a density lower than the density of the flat part.

Now, the sheet-like gaskets (1), (2), and (3) are first described. The sheet-like gaskets (1), (2), and (3) of the present invention have a bead on both sides or one side, specifically on both sides or one side of the surface which comes in contact with a flange surface of high pressure equipment and the bead has a density smaller than the density of the flat part.

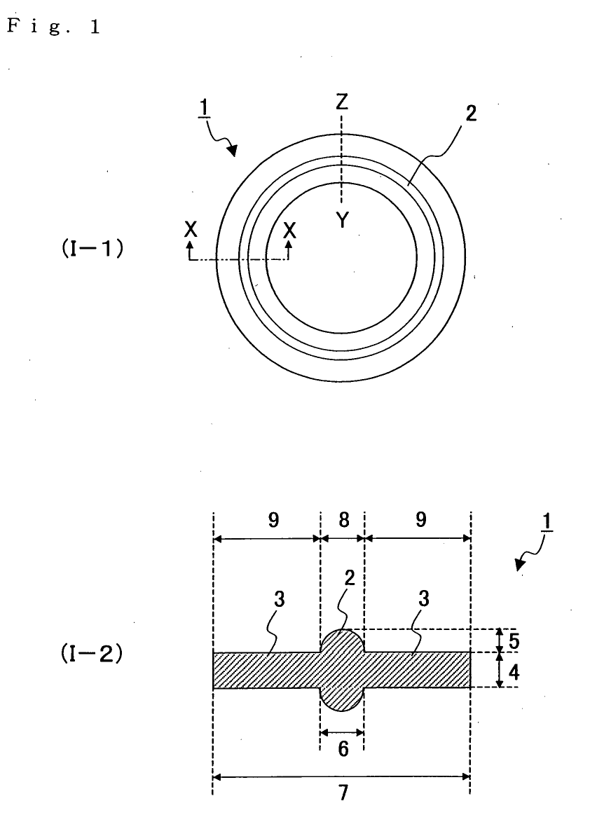

FIG. 1 shows a sheet-like gasket of one embodiment of the present invention, used for connecting high pressure pipes by being inserted between flanges of the high pressure pipes. In FIG. 1, (I-1) shows a plan view of the sheet-like gasket and (I-2) shows an enlarged cross-sectional view of the sheet-like gasket along X-X. In the use state of the sheet-like gasket in FIG. 1 (I-1), the inner side of the sheet-like gasket 1 is a high pressure region Y and the outer side is a low pressure region Z.

In FIG. 1, a bead 2, which is a continuous projection extending in the circular direction of the sheet-like gasket 1, is formed on the surface which comes in contact with a flange surface. The bead 2 is formed on both sides of the sheet-like gasket, surrounding the high pressure region Y Specifically, the bead 2 is formed on both sides of the sheet-like gasket 1 in the manner such that the bead 2 crosses a line Y-Z (shown by a dotted line in FIG. 1 (I-1)) connecting the high pressure region Y and the low pressure region Z.

Although the bead 2 may be formed on either one of the sides or both sides of the sheet-like gasket, a bead 2 formed on both sides is preferred for promoting sealing performance of the sheet-like gasket.

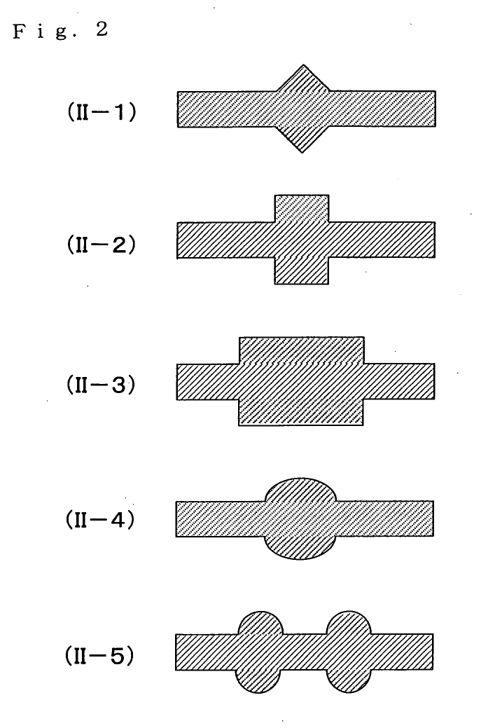

Although the bead with a cross-section of a half circular shape is shown in FIG. 1, the shape is not necessarily limited to the half circle, but may be another cross-sectional shape such as a triangle (FIG. 2 (II-1)), a rectangle (FIG. 2 (II-2), (II-3)), a half ellipse (FIG. 2 (II-4)), or the like. When the bead is formed on both sides of the sheet-like gasket, the cross-sectional shape on either side may be the same or different. Although one bead is formed on one side of the sheet-like gasket 1 in FIG. 1, the number of beads is not limited to one, but may be two or more. When there are two or more beads, the cross-sectional shape may be either the same or different. For example, in the sheet-like gasket shown in FIG. 2 (II-5), the number of beads formed on one side crossing the line connecting the high pressure region and low pressure region is two.

The density of the bead 2 is lower than the density of the flat part 3. In the present invention, a flat part refers to the area of the sheet-like gasket on which the bead is not formed.

The density of the bead 2 is preferably from 0.5 to 2.5 g/cm³, and particularly preferably from 0.5 to 1.5 g/cm³. The density of the flat part 3 is preferably from 1.0 to 2.5 g/cm³, and particularly preferably from 1.5 to 2.0 g/cm³. If the density of the bead 2 is locally inspected, the density usually differs according to the area of the bead 2. In the present invention the density of the bead 2 refers to the average density of the entire bead 2. This is also applied to the density of the flat part 3. The density of the flat part 3 refers to the average density of the entire flat part 3.

Although not specifically limited, the difference in density of the flat part 3 and the bead 2, {(density of flat part)−(density of bead)}, is preferably from 0.2 to 2.0 g/cm³, and particularly preferably from 0.5 to 1.7 g/cm³. The difference in density of the flat part 3 and the bead 2 in the above range promotes the sealing performance of the sheet-like gasket.

The thickness 4 of the sheet-like gasket 1 (thickness of the flat part) varies according to the object for which the sheet-like gasket is used in an approximate range from 1.0 to 15.0 mm, and preferably from 1.5 to 10.0 mm.

Although not specifically limited, the height 5 of the bead 2 is preferably from 0.1 to 10.0 mm, and particularly preferably from 0.5 to 8.0 mm. The height 5 of the bead 2 in the above range promotes the sealing performance of the sheet-like gasket.

Although not specifically limited, the ratio of the height 5 of the bead 2 to the thickness 4 of the sheet-like gasket 1, {(height of bead)/(thickness of sheet-like gasket)}, is preferably from 0.01 to 0.8, and particularly preferably from 0.1 to 0.6. The ratio of the height 5 of the bead 2 to the thickness 4 of the sheet-like gasket 1 in the above range promotes the sealing performance of the sheet-like gasket.

The width 6 of the bead 2 is selected from an appropriate range taking the width 7 of the sealing face into consideration, preferably from 0.5 to 15.0 mm, and particularly preferably from 1.0 to 10.0 mm. The width 6 of the bead 2 in the above range promotes the sealing performance of the sheet-like gasket. The ratio of the width 6 of the bead 2 to the width 7 of the sealing face, {(width of bead)/(width of sealing face)}, is preferably from 0.02 to 0.6, and particularly preferably from 0.04 to 0.4. The ratio of the width 6 of the bead 2 to the width 7 of the sealing face in the above range promotes the sealing performance of the sheet-like gasket.

The substrate fiber of the sheet-like gasket (1) of the present invention may be either organic fiber or a combination of organic fiber and inorganic fiber. There are no specific limitations to the type of organic fiber inasmuch as the organic fiber can be used for a sheet-like gasket. Examples that can be given include aromatic polyamide fiber, poly(p-phenylenebenzobisoxazole) fiber (PBO fiber), polyolefin fiber, polyester fiber, polyacrylonitrile fiber, polyvinyl alcohol fiber, polyvinyl chloride fiber, poly urea fiber, polyurethane fiber, polyfluorocarbon fiber, and cellulose fiber. Of these, aromatic polyamide fiber and poly(p-phenylenebenzobisoxazole) fiber are preferable in order to increase heat resistance of the sheet-like gasket. These organic fibers may be used either individually or in combination of two or more. Examples of the inorganic fiber include, but are not limited to, carbon fiber, glass fiber, rock wool, and the like.

In the sheet-like gasket (1) of the present invention, the content of substrate fiber in the composition comprising the substrate fiber, rubber materials, fillers, and rubber chemicals is from 3 to 50 wt %, and preferably from 7 to 30 wt % of the total amount of the substrate fiber, rubber materials, fillers, and rubber chemicals.

There are no specific limitations to the rubber material used in the sheet-like gasket (1) of the present invention inasmuch as the material can be used for a sheet-like gasket. Examples that can be given include acrylonitrile-butadiene rubber, hydrogenated acrylonitrile-butadiene rubber, acrylic rubber, ethylene-propylene rubber, styrene-butadiene rubber, chloroprene rubber, butadiene rubber, isobutylene-isoprene rubber, fluororubber, silicone rubber, chlorosulfonated polyethylene rubber, ethylene-vinyl acetate rubber, chlorinated polyethylene rubber, chlorinated isobutylene-isoprene rubber, epichlorohydrin rubber, nitrile-isoprene rubber, natural rubber, and isoprene rubber. Of these, acrylonitrile-butadiene rubber is preferable from the viewpoint of increasing oil resistance of the sheet-like gasket. These rubber materials may be used either individually or in combination of two or more.

In the sheet-like gasket (1) of the present invention, the content of rubber materials in the composition comprising the substrate fiber, rubber materials, fillers, and rubber chemicals is from 5 to 40 wt %, and preferably from 7 to 30 wt % of the total amount of the substrate fiber, rubber materials, fillers, and rubber chemicals.

There are no specific limitations to the filler used in the sheet-like gasket (1) of the present invention inasmuch as the filler can be used for a sheet-like gasket. Examples that can be given include kaolin clay, talc, barium sulfate, sodium bicarbonate, mica, graphite, sericite, wollastonite, white carbon, sintered clay, aluminum hydroxide, magnesium hydroxide, and glass beads.

In the sheet-like gasket (1) of the present invention, the content of the fillers in the composition comprising the substrate fiber, rubber materials, fillers, and rubber chemicals is from 25 to 80 wt %, and preferably from 40 to 60 wt % of the total amount of the substrate fiber, rubber materials, fillers, and rubber chemicals.

The rubber chemical for the sheet-like gasket (1) of the present invention is a mixture of a cross-linking agent and other known additives optionally used for sheet-like gaskets such as a cross-linking promoter, an aging preventive, an anti-scorching agent, a plasticizer, and a coloring agent.

The crosslinking agent in the rubber chemicals causes a crosslinking reaction with the rubber material by heating and forms a three-dimensional network structure. The crosslinking agent changes into a crosslinking component that links rubber material molecules by the cross-linking reaction. As the crosslinking agent, any compound can be used without specific limitations inasmuch as the compound can be used as a crosslinking agent for a sheet-like gasket. Sulfur, zinc oxide, magnesium oxide, peroxide, dinitrobenzene, alkylphenol resin, and the like can be given as examples.

Although not specifically limited, the content of the crosslinking agent in the rubber chemical is preferably from 0.1 to 20.0 wt %, and particularly preferably from 0.5 to 15.0 wt %.

The cross-linking promoter in the rubber chemicals promotes the crosslinking reaction of the rubber material and the crosslinking agent. As examples, a polyamine compound, aldehydeamine compound, thiuram compound, dithiocarbamate compound, sulfeneamide compound, thiazole compound, guanidine compound, thiourea compound, xanthate compound, and the like can be given.

As the aging preventives, anti-scorching agents, plasticizers, and coloring agents in the rubber chemicals, any known components that are used in sheet-like gaskets can be used without any specific limitations.

There are no specific limitations to the method for forming the composition comprising the substrate fiber, rubber material, filler, and rubber chemical used for the sheet-like gasket (1) of the present invention. One example of such a method comprises a slurry preparing step of preparing a raw slurry containing the composition, a molding step of obtaining a gasket substrate sheet by molding the raw slurry into a sheet and drying the sheet, a compression step of obtaining a compressed sheet by compressing the resulting molded gasket substrate sheet and forming flat parts and beads, and a cross-linking step of obtaining the sheet-like gasket by causing a cross-linking reaction by heating the compressed sheet.

The sheet-like gasket (2) of the present invention is obtained by making the compression rate of the area in which the beads are formed smaller than the compression rate of the area in which the flat part is formed in a compression step in the process comprising a slurry preparing step of preparing a raw slurry containing a substrate fiber, rubber material, filler, and rubber chemical, a molding step of obtaining a gasket substrate sheet by molding the raw slurry into a sheet and drying the sheet, a compression step of obtaining a compressed sheet by compressing the resulting molded gasket substrate sheet and forming flat parts and beads, and a cross-linking step of obtaining the sheet-like gasket by causing a cross-linking reaction by heating the compressed sheet.

In the sheet-like gasket (2) of the present invention, the substrate fiber, rubber materials, fillers, and rubber chemicals used in the slurry preparing step are the same as those used for the sheet-like gasket (1) of the present invention.

In the slurry preparing step, the raw slurry is prepared by dispersing the substrate fiber, rubber materials, fillers, and rubber chemicals in a solvent such as water. Specifically, the raw slurry is prepared by dispersing the substrate fiber in water using a refiner, adding the rubber materials, fillers, and rubber chemicals to the dispersion, and further adding a coagulant, for example.

The raw slurry may contain a coagulant for improving moldability in the molding step. As the coagulant, commonly known coagulants for sheet-like gasket production can be used.

The content of the substrate fiber in the raw slurry is from 3 to 50 wt %, and preferably from 7 to 30 wt % of the total amount of the substrate fiber, rubber materials, fillers, and rubber chemicals.

The content of the rubber materials in the raw slurry is from 5 to 40 wt %, and preferably from 7 to 30 wt % of the total amount of the substrate fiber, rubber materials, fillers, and rubber chemicals.

The content of the fillers in the raw slurry is from 25 to 80 wt %, and preferably from 40 to 60 wt % of the total amount of the substrate fiber, rubber materials, fillers, and rubber chemicals.

The content of the rubber chemicals in the raw slurry is from 0.1 to 20 wt %, and preferably from 0.5 to 15 wt % of the total amount of the substrate fiber, rubber materials, fillers, and rubber chemicals.

The molding step in the process for producing the sheet-like gasket (2) of the present invention is a step of obtaining the gasket substrate sheet by molding the raw slurry into a sheet and drying the sheet.

There are no specific limitations to the method for molding the raw slurry into a sheet. A method of making the raw slurry into a sheet, a method of forming the raw slurry using a calendar roller, and the like can be given. Of these methods, the method of making the raw slurry into a sheet, particularly using a cylinder mold machine, is preferable due to the high yield.

Next, the molded product obtained is dried. The drying temperature is less than the temperature at which the rubber material reacts with the cross-linking agent and varies according to the type of the cross-linking agent in a range of about 20 to 150° C., and preferably 40 to 100° C. The drying time is from 0.1 to 48 hours, and preferably from 6 to 24 hours.

The thickness of the gasket substrate sheet is selected from an appropriate range, taking the thickness of the sheet-like gasket into consideration, preferably from 1.2 to 30.0 mm, and particularly preferably from 2.0 to 20.0 mm.

Before being sent to the compression step subsequent to the molding step, the gasket substrate sheet may be formed to have a plane shape of a sheet-like gasket by punching or the like.

The compression step in the process for producing the sheet-like gasket (3) of the present invention is a step of compressing the gasket substrate sheet to form a flat part and a bead, thereby obtaining the compressed sheet.

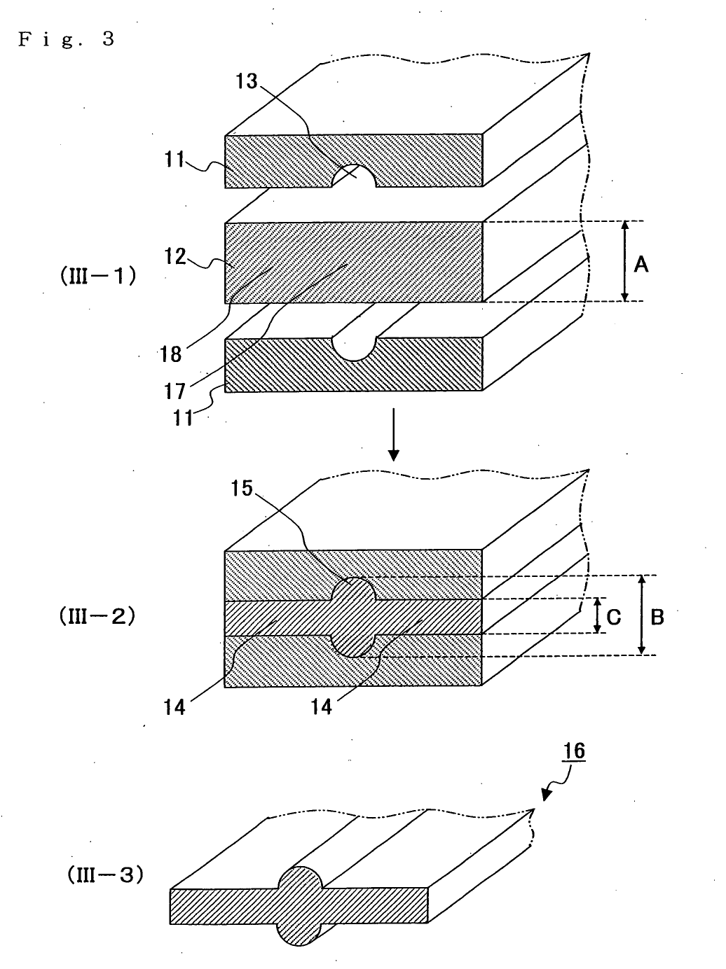

The compression step is explained in reference to FIG. 3. FIG. 3 is a schematic diagram showing the manner of obtaining a compressed sheet by compressing the gasket substrate sheet in the compression step, in which a perspective view of the cross-section of the gasket substrate sheet and the die is shown when cut in a plane perpendicularly crossing the circular direction. In FIG. 3, (III-1) shows the state before compression, (III-2) shows the state during compression, and (III-3) represents a compressed sheet obtained by compression.

A gasket substrate sheet 12 formed in the same plane configuration with the sheet-like gasket is put between dies 11 and 11 having the same plane configuration as the sheet-like gasket and a recess 13 continuously formed in the circumferential direction (III-1) and pressed by the dies 11 and 11 until the thickness of the plane part 14 of the compressed sheet becomes a prescribed thickness to form the plane part 14 and a bead 15 of the compressed sheet (III-2), thereby obtaining the compressed sheet 16 having the bead (III-3).

In the compression step, the compression rate of the portion 17 in which the bead is formed is smaller than the compression rate of the portion 18 in which the flat part is formed. In the compression step shown in FIG. 3, since the dies 11 and 11 have the recess 13, the gasket substrate 12 is not compressed or, if compressed, compressed only at a small compression rate in the recess 13. Specifically, the compression rate of the portion 17 in which the bead is formed can be smaller than the compression rate of the portion 18 in which the flat part is formed by pressing the gasket substrate sheet using the die having a recess continuous in the circular direction. The compression rate in this invention refers to a percentage of compression of a compressed sheet in the thickness of the gasket substrate sheet before compression. Assuming that the thickness of the gasket substrate sheet 12 before compression is A, the thickness of the part in which the bead is formed after compression is B, and the thickness of the part in which the flat part is formed after compression is C in FIG. 3, the compression rate D of the part 17 in which the bead is formed can be determined by the following formula (1),
Compression rate D(%)={(A−B)/A}×100 (1)
The compression rate E of the part 18 in which the flat part is formed can be determined by the following formula (2),
Compression rate E(%)={(A−C)/A}×100 (2)
The density of the bead 15 in the compressed sheet can be made smaller than the density of the flat part 14 of the compressed sheet by making the compression rate D of the part 17 in which the bead is formed be smaller than the compression rate E of the part 18 in which the flat part is formed. For this reason, the density of the bead of the sheet-like gasket (2) of the present invention is lower than the density of the flat part.

The compression rate E of the part 18 in which the flat part is formed is preferably from 5 to 80%, and particularly preferably from 30 to 70%.

There are no specific limitations to the difference between the compression rate E of the part 18 in which the flat part is formed and the compression rate D of the part 17 in which the bead is formed (Compression rate E−Compression rate D), but such a difference is preferably from 5 to 80%, and particularly preferably from 30 to 70%. The difference between the compression rate E of the part 18 in which the flat part is formed and the compression rate D of the part 17 in which the bead is formed in the above range promotes the sealing performance of the sheet-like gasket.

The thickness C of the flat part 14 of the compressed sheet is preferably from 1.0 to 15.0 mm, and particularly preferably from 1.5 to 10.0 mm.

The temperature of the die 11 during compression in the compression step is from 20 to 200° C., and preferably from 100 to 160° C. If the temperature of the die 11 is equal to or higher than the temperature of the cross-linking reaction of the rubber material with the cross-linking agent, the cross-linking occurs near the surface of the compressed sheet 16 during the compression. It is also possible to heat the die 11 to a temperature equal to or higher than the temperature at which the rubber material cross-links with the cross-linking agent and to hold the compressed sheet 16 between the pair of dies 11 and 11 after the compression for a prescribed period of time, thereby continuously performing the compression step and cross-linking step.

The cross-sectional configuration and number of recesses 13 are suitably selected according to the cross-sectional configuration and the number of beads formed in the sheet-like gasket. The width of the die 11 is not specifically limited insofar as the width is larger than the width of the gasket substrate sheet 12.

If the gasket substrate sheet before compression is not formed into the plane shape of the sheet-like gasket, the gasket substrate sheet may be punched into the plane shape of the sheet-like gasket while being compressed during the compression step.

The cross-linking step in the process for producing the sheet-like gasket (2) of the present invention is a step of obtaining the sheet-like gasket by heating the compressed sheet to effect the cross-linking reaction.

The heating temperature of the compressed sheet in the cross-linking step is the same as or more than the temperature at which the rubber material reacts with the cross-linking agent and varies according to the type of the cross-linking agent in a range of preferably 100 to 200° C., and particularly preferably 120 to 160° C. The heating time of the compressed sheet is from 0.5 to 120 minutes, and preferably from 1 to 60 minutes.

Heating of the compressed sheet in this manner causes the crosslinking reaction by which the crosslinking agent cross-links with two or more rubber material molecules in the cross-linking step.

When the sheet-like gasket (2) is clamped, the area in which the bead is formed (the area shown by 8 in FIG. 1 (I-2)) has a density almost equivalent to the density of the area in which the flat part is formed (the area shown by 9 in FIG. 1 (I-2)), specifically, that area is as dense as the flat part. Therefore, high sealing performance of the sheet-like gasket can be ensured.

The same substrate fibers, rubber materials, and fillers as used in the sheet-like gasket (1) can be used for the sheet-like gasket (3).

The cross-linking component used for the sheet-like gasket (3) of the present invention is a component for cross-linking rubber materials and forms a three-dimensional network structure in the sheet-like gasket together with the rubber materials. The cross-linking component is a modified material of the cross-linking agent in the sheet-like gasket (1) produced by the cross-linking reaction.

The sheet-like gasket (3) of the present invention may further contain a modified cross-linking promoter produced by the cross-linking reaction and known additives conventionally used for sheet-like gaskets such as an aging preventive, an anti-scorching agent, a plasticizer, and a coloring agent.

In the sheet-like gasket (3) of the present invention, the content of substrate fiber in the sheet-like gasket is from 3 to 50 wt %, and preferably from 7 to 30 wt %.

In the sheet-like gasket (3) of the present invention, the content of rubber materials in the sheet-like gasket is from 5 to 40 wt %, and preferably from 7 to 30 wt %.

In the sheet-like gasket (3) of the present invention, the content of the fillers in the sheet-like gasket is from 25 to 80 wt %, and preferably from 40 to 60 wt %.

In the sheet-like gasket (3) of the present invention, the content of the cross-linking agent in the sheet-like gasket is from 0.1 to 20 wt %, and preferably from 0.5 to 15.0 wt %.

Since the density of the flat parts of the sheet-like gaskets (1) and (3) of the present invention is 1.0 g/cm³ or more and the sheet-like gasket (2) of the present invention is obtained by compressing the gasket substrate sheet, all of them have a dense structure.

The process for manufacturing the sheet-like gasket of the present invention comprises a slurry preparing step of obtaining a raw slurry containing a substrate fiber, a rubber material, a filler, and a rubber chemical, a molding step of obtaining a gasket substrate sheet by molding the raw slurry into a sheet and drying the sheet, a compression step of obtaining a compressed sheet by compressing the molded gasket substrate sheet and forming a flat part and a bead, and a cross-linking step of obtaining the sheet-like gasket by causing a cross-linking reaction by heating the compressed sheet, wherein the compression rate of the area in which the bead is formed is smaller than the compression rate of the area in which the flat part is formed in the compression step.

The substrate fiber, rubber materials, fillers, rubber chemicals, raw slurry, slurry preparing step, molding step, compression step, and cross-linking step in the process for manufacturing the sheet-like gasket of the present invention are the same as the substrate fiber, rubber materials, fillers, rubber chemicals, raw slurry, slurry preparing step, molding step, compression step, and cross-linking step of the sheet-like gasket (2) of the present invention.

The process for manufacturing the sheet-like gasket of the present invention can be preferably used for producing the sheet-like gaskets (1), (2), and (3) of the present invention.

Since the density of the bead is smaller than the flat part in the sheet-like gaskets (1), (2), and (3) of the present invention, these sheet-like gaskets have high elasticity. When clamped, the area in which the bead is formed (the area shown by 8 in FIG. 1 (I-2)) is compressed more than the area in which the flat portion is formed (the area shown by 9 in FIG. 1 (I-2)), stress concentrates on the bead during clamping, resulting in a high plane pressure of the part in which the bead is formed.

Because the bead has a density smaller than the density of the flat part, denseness of the part in which the bead is formed is small before clamping. However, since the part in which the bead is formed is compressed and its thickness is reduced to the same thickness as the part in which the flat part is formed by clamping, the density of the part in which the bead is formed is increased. Specifically, the denseness of the area in which the bead is formed increases by clamping. In particular, in the sheet-like gaskets (2) of the present invention, the density of the area in which the bead is formed is increased to approximately the same density of the area in which the flat part is formed. For this reason, the sealing performance of the area in which the bead is formed after clamping is higher than before clamping.

Because the sealing performance of the area in which the bead is formed is increased for these reasons, the sheet-like gaskets of the present invention can exhibit sufficient sealing performance with a small clamping force.

As discussed above, the sheet-like gaskets (1), (2), and (3) of the present invention have a dense structure and exhibit excellent sealing performance with a small clamping force even on an irregular flange surface.

The present invention will be described in more detail by examples, which should not be construed as limiting the present invention.

### EXAMPLES

### Example 1

(Preparation of Gasket Substrate Sheet)

A refiner was charged with 15 parts by weight of a substrate fiber (aromatic polyaramide fiber) and 1,000 parts by weight of water to disperse the substrate fiber in water. 30 parts by weight of a rubber material (NBR), 40 parts by weight of a filler (kaolin clay), 15 parts by weight of a rubber chemical, and 10 parts by weight of a coagulant were added to obtain a raw slurry. The raw slurry was made into a sheet using a cylinder machine and dried at 100° C. for one hour to obtain a gasket substrate sheet with a thickness of 3.0 mm.

(Preparation of Sheet-Like Gasket)

The gasket substrate sheet was punched into a doughnut shape with an inner diameter of 35 mm and an outer diameter of 74 mm, and pressed using a die A heated to 100° C. to obtain a compressed sheet with a thickness of the flat part of 1.5 mm. In this instance, the compression rate D was 0% and the compression rate E was 50%. The compressed sheet was heated in an oven at 150° C. for 0.5 hour to obtain a sheet-like gasket. The density of the flat part of the sheet-like gasket was 2.0 g/cm³ and the density of the bead was 1.0 g/cm³.

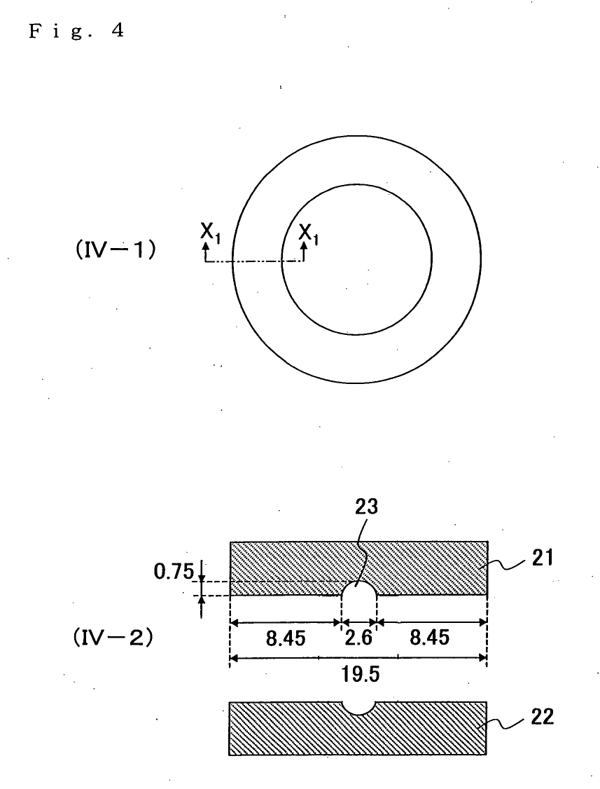

The die A has a shape of a doughnut with an inner diameter of 35 mm and an outer diameter of 74 mm as shown in FIG. 4, wherein (IV-1) is a plan view and (IV-2) shows an enlarged cross-sectional view of the end along X₁-X₁ in (IV-1). In FIG. 4, the cross-section of the recess 23 is part of a circle with a radius of 1.5 mm, of which the circular arc is equivalent to one third of the circumference of the circle with a radius of 1.5 mm. The shape of the lower side member 22 is vertically symmetrical with the shape of the upper side member 21. The unit used in the drawing is “mm”.

(Evaluation of Sealing Performance)

The sheet-like gasket obtained was applied to a JIS10K25A flange with a surface coarseness of 25 Rz and clamped at a clamping force of 75 kN. A nitrogen gas load at a pressure of 1.0 MPa was applied. The flange was immersed in water to collect leaking nitrogen gas in 10 minutes. Leakage per minute was calculated from the volume of collected nitrogen gas. The results are shown in Table 1.

### Example 2

(Preparation of Gasket Substrate Sheet, Preparation of Sheet-Like Gasket, and Evaluation of Sealing Performance)

The same experiment as in Example 1 was carried out except for using a die B instead of the die A. In this instance, the compression rate D was 0% and the compression rate E was 50%. The density of the flat part of the sheet-like gasket was 2.0 g/cm³ and the density of the bead was 1.0 g/cm³. The results of the seal performance evaluation are shown in Table 1.

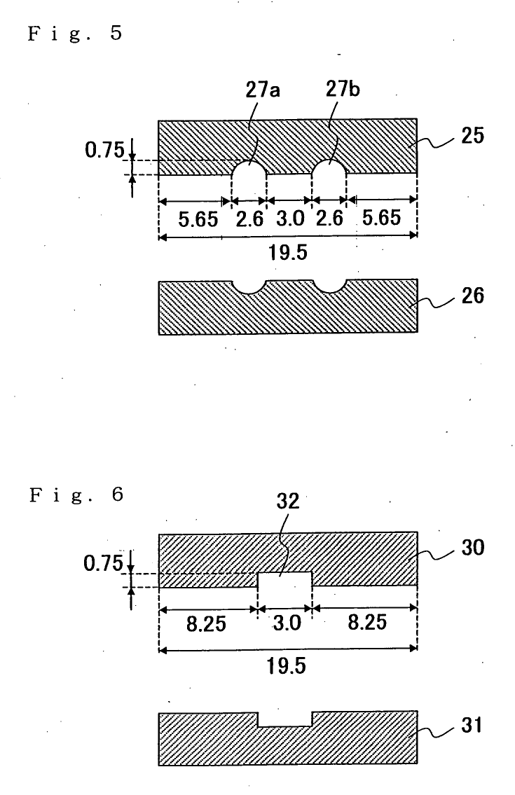

The die B has a shape of a doughnut with an inner diameter of 35 mm and an outer diameter of 74 mm. The plan view of the die B is the same as the plan view of the die A. A cross-sectional view of the end along X₁-X₁ is shown in FIG. 5. In FIG. 5, the cross-section of the recesses 27a and 27b are respectively part of a circle with a radius of 1.5 mm, of which the circular arc is equivalent to one third of the circumference of the circle with a radius of 1.5 mm. The shape of the lower side member 26 is vertically symmetrical with the shape of the upper side member 25. The unit used in the drawing is “mm”.

### Example 3

(Preparation of Gasket Substrate Sheet, Preparation of Sheet-Like Gasket, and Evaluation of Sealing Performance)

The same experiment as in Example 1 was carried out except for using a die C instead of the die A. In this instance, the compression rate D was 0% and the compression rate E was 50%. The density of the flat part of the sheet-like gasket was 2.0 g/cm³ and the density of the bead was 1.0 g/cm³. The results of the seal performance evaluation are shown in Table 1.

The die C has a shape of a doughnut with an inner diameter of 35 mm and an outer diameter of 74 mm. The plan view of the die C is the same as the plan view of the die A. A cross-sectional view of the end along X₁-X₁ is shown in FIG. 6. In FIG. 6, the cross-section of the recess 32 is a rectangle with a width of 3.0 mm and a height of 0.75 mm. The shape of the lower member 31 is vertically symmetrical with the shape of the upper member 30. The unit used in the drawing is “mm”.

### Comparative Example 1

(Preparation of Gasket Substrate Sheet)

A gasket substrate sheet with a thickness of 3.0 mm was prepared in the same manner as in the Example 1.

(Preparation of Sheet-Like Gasket)

The gasket substrate sheet was heated in an oven at 150° C. for 0.5 hour and punched into a shape of a doughnut with an inner diameter of 35 mm and an outer diameter of 74 mm to obtain a sheet-like gasket. This sheet-like gasket was not compressed and had no bead formed therein.

(Evaluation of Sealing Performance)

The same experiment as in Example 1 was carried out except for using the resulting sheet-like gasket. The results are shown in Table 1.

### Comparative Example 2

(Preparation of Gasket Substrate Sheet)

A gasket substrate sheet with a thickness of 3.0 mm was prepared in the same manner as in the Example 1.

(Preparation of Sheet-Like Gasket)

The gasket substrate sheet was passed through a hot roller heated at 100° C. and rolled at a load of linear pressure of 5 N/m or more to obtain a rolled sheet with a thickness of 1.5 mm. The rolled sheet was heated in an oven at 150° C. for 0.5 hour and punched into a shape of a doughnut with an inner diameter of 35 mm and an outer diameter of 74 mm to obtain a sheet-like gasket. This sheet-like gasket was compressed, but had no bead formed therein.

(Evaluation of Sealing Performance)

The same experiment as in Example 1 was carried out except for using the resulting sheet-like gasket. The results are shown in Table 1.

TABLE 1

| | | | | Comparative | |
|---|---|---|---|---|---|
| | Example | | | Example | |
| | 1 | 2 | 3 | 1 | 2 |
| N₂ leakage amount (cm³/min) | 0.02 | 0.01 | 0.05 | 0.30 | 1.00 |

What is claimed is:

1. A sheet-like gasket obtained by molding a composition comprising a substrate fiber, a rubber material, a filler, and a rubber chemical, having a bead on both sides or one side, and having a flat part with a density of 1 g/cm³ or higher, the bead having a density lower than the density of the flat part.

2. A sheet-like gasket obtained by a process comprising a slurry preparing step of obtaining a raw slurry containing a substrate fiber, a rubber material, a filler, and a rubber chemical, a molding step of obtaining a gasket substrate sheet by molding the raw slurry into a sheet and drying the sheet, a compression step of obtaining a compressed sheet by compressing the molded gasket substrate sheet and forming a flat part and a bead, and a cross-linking step of obtaining the sheet-like gasket by causing a cross-linking reaction by heating the compressed sheet, wherein the compression rate of the area in which the bead is formed is smaller than the compression rate of the area in which the flat part is formed in the compression step.

3. A sheet-like gasket comprising a substrate fiber, a rubber material, a filler, and a cross-linking component, having a bead on both sides or one side, and having a flat part with a density of 1 g/cm³ or higher, the bead having a density lower than the density of the flat part.

4. A process for manufacturing a sheet-like gasket comprising a slurry preparing step of obtaining a raw slurry containing a substrate fiber, a rubber material, a filler, and a rubber chemical, a molding step of obtaining a gasket substrate sheet by molding the raw slurry into a sheet and drying the sheet, a compression step of obtaining a compressed sheet by compressing the molded gasket substrate sheet and forming a flat part and a bead, and a cross-linking step of obtaining the sheet-like gasket by causing a cross-linking reaction by heating the compressed sheet, wherein the compression rate of the area in which the bead is formed is smaller than the compression rate of the area in which the flat part is formed in the compression step.
